(19) United States
(12) Patent Application Publication
(10) Pub. No.: US 2025/0073746 A1
(43) Pub. Date: Mar. 6, 2025

(54) BATTERY ELECTRODE MATERIAL COATING DEVICE

(71) Applicant: TOYOTA JIDOSHA KABUSHIKI KAISHA, Toyota-shi (JP)

(72) Inventors: Masashi Ueda, Toyota-shi (JP); Tomoko Higo, Toyota-shi (JP); Shinji Kojima, Nagoya-shi (JP)

(73) Assignee: TOYOTA JIDOSHA KABUSHIKI KAISHA, Toyota-shi (JP)

(21) Appl. No.: 18/655,480

(22) Filed: May 6, 2024

(30) Foreign Application Priority Data
Sep. 4, 2023 (JP) 2023-143059

(51) Int. Cl. B05C 19/02; B05C 13/02; B05C 19/00

(52) U.S. Cl. CPC B05C 19/025; B05C 13/02; B05C 19/008

(57) ABSTRACT

A battery electrode material coating device includes a conveying unit that conveys a conductive base material, a hopper configured to be capable of accommodating powder and having a conductive screen, a voltage applying unit capable of applying a voltage between the conveying unit and the hopper, and an ultrasonic transducer connected to a sidewall of the hopper.

### CROSS-REFERENCE TO RELATED APPLICATION

This application claims priority to Japanese Patent Application No. 2023-143059 filed on Sep. 4, 2023, incorporated herein by reference in its entirety.

### BACKGROUND

### 1. Technical Field

The present disclosure relates to battery electrode material coating devices.

### 2. Description of Related Art

Japanese Unexamined Patent Application Publication No. H07-109031 (JP H07-109031 A) discloses a granular material supply device in which a screen is disposed in a lower part of a hopper. Particularly in the device disclosed in JP H07-109031 A, a plurality of vibrating plates is installed under the screen inside the hopper. Since an ultrasonic transducer is attached to a vibrating connecting rod connecting the vibrating plates, this device is structured to uniformly apply vibration to the granular material contained in the hopper.

### SUMMARY

However, the device described in JP H07-109031 A may not be able to uniformly coat a coating target with powder because the powder hits the vibrating connecting rod before being discharged.

An object of the present disclosure is to provide a battery electrode material coating device that can uniformly coat a coating target with powder.

A battery electrode material coating device according to claim 1 includes: a conveying unit configured to convey an electrically conductive base material; a hopper configured to store powder and including an electrically conductive screen; a voltage applying unit configured to apply a voltage between the conveying unit and the hopper; and an ultrasonic transducer connected to a sidewall of the hopper.

In the battery electrode material coating device according to claim 1, the electrically conductive base material is conveyed by the conveying unit. The hopper is configured to store powder, and the electrically conductive screen is installed in the hopper. A voltage can be applied between the conveying unit and the hopper by the voltage applying unit. A predetermined amount of powder is thus supplied from the hopper to the base material conveyed by the conveying unit, so that the base material is coated with the powder. Since the ultrasonic transducer is connected to the sidewall of the hopper, the powder with ultrasonic vibration applied thereto can be supplied from the screen to the base material. The base material that is a coating target can thus be uniformly coated with the powder.

In a battery electrode material coating device according to claim 2, in claim 1, the screen may be installed in a discharge port of the hopper.

In the battery electrode material coating device according to claim 2, the screen is installed in the discharge port of the hopper. Therefore, the powder can be supplied to the base material immediately after passing through the screen.

In a battery electrode material coating device according to claim 3, in claim 1, the ultrasonic transducer may be connected to a portion of the hopper that is located below a middle portion in an up-down direction of the hopper.

In the battery electrode material coating device according to claim 3, the ultrasonic transducer is connected to the portion of the hopper that is located below (downstream of) the middle portion in the up-down direction of the hopper. Therefore, ultrasonic vibration can be effectively applied to the powder near the discharge port.

In a battery electrode material coating device according to claim 4, in any one of claims 1 to 3, the hopper may be disposed in such a manner that a longitudinal direction of the hopper is perpendicular to a conveying direction of the base material by the conveying unit, and the ultrasonic transducer may be connected to a middle portion in the longitudinal direction of the hopper.

In the battery electrode material coating device according to claim 4, the hopper is disposed in such a manner that the longitudinal direction of the hopper is perpendicular to the conveying direction of the base material by the conveying unit. In other words, since the length in the conveying direction of the discharge port of the hopper is reduced, the powder can be more uniformly applied in the conveying direction.

As described above, according to the battery electrode material coating device of the present disclosure, a coating target can be uniformly coated with the powder.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an overall configuration of a battery electrode material coating device according to an embodiment;

FIG. 2 is a view schematically showing an entire configuration of a battery electrode material coating device according to a modification; and

FIG. 3 is a diagram schematically showing an overall configuration of a battery electrode material coating device according to a comparative example.

### DETAILED DESCRIPTION OF EMBODIMENTS

A battery electrode material coating device 10 according to an embodiment will be described with reference to the drawings.

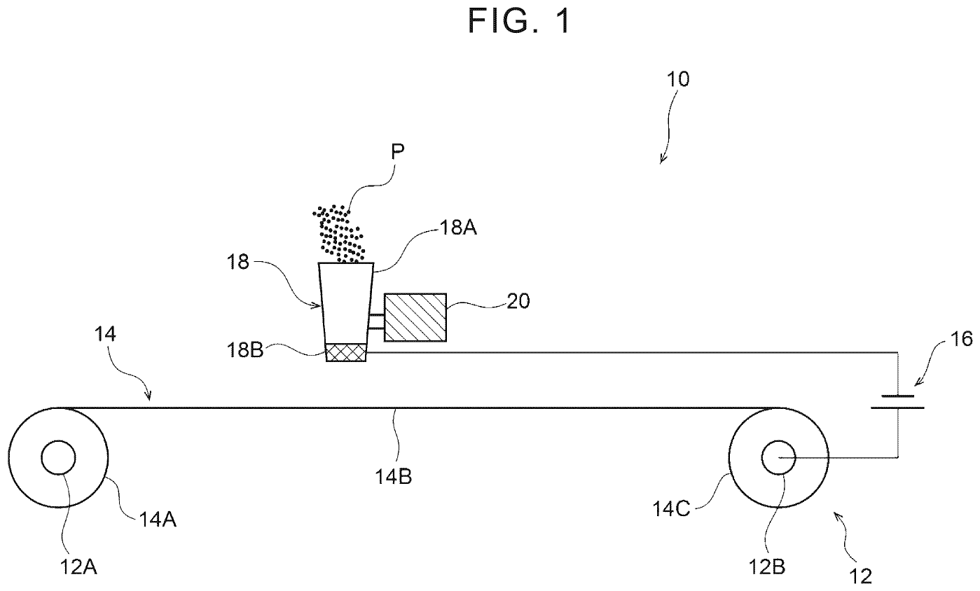

FIG. 1 is a diagram schematically showing an overall configuration of a battery electrode material coating device 10 according to the present embodiment. As shown in FIG. 1, the battery electrode material coating device 10 according to the present embodiment is a coater for manufacturing an electrode plate of a battery, and includes a conveying unit 12, a hopper 18, a power supply 16 as a voltage applying unit, and an ultrasonic transducer 20.

The conveying unit 12 includes a supply-side roller 12A and a recovery-side roller 12B, and each of the supply-side roller 12A and the recovery-side roller 12B is configured to rotate when a motor (not shown) is operated.

A conductive base material 14 is wound between the supply-side roller 12A and the recovery-side roller 12B. As the base material 14, a metal foil or the like is used, and for example, a copper foil, an aluminum foil, or the like is used in a state of being wound in a roll shape.

The supply-side roller 12A is wound with a pre-coating base material 14A before coated with the powder in a roll shape, and the recovery-side roller 12B is wound with a post-coating base material 14C after the powder is applied in a roll shape. By operating a motor (not shown), the supply-side roller 12A and the recovery-side roller 12B rotate, and the base material 14 is conveyed from the supply-side roller 12A to the recovery-side roller 12B. A hopper 18 is provided above the base material 14B being conveyed during conveyance between the supply-side roller 12A and the recovery-side roller 12B.

The hopper 18 is formed in such a manner that the upper and lower end portions thereof are opened and gradually narrower toward the lower side, and includes a main body portion 18A and a screen 18B.

The body portion 18A of the hopper 18 is disposed in such a manner that its longitudinal direction is perpendicular to the conveying direction of the base material 14 by the conveying unit 12. That is, the main body portion 18A is disposed with the depth direction of the plane of FIG. 1 as the longitudinal direction. For example, the longitudinal length of the body portion 18A may be slightly shorter than the width of the base material 14 to be transported. The length of the body portion 18A in the conveying direction (lateral direction) is set to, for example, 10 mm or less.

The powder P is supplied from a supply hole at an upper end portion of the main body portion 18A. As the powder P, an active material and a binder constituting an electrode material are used. For example, in the case of a negative electrode material of a lithium ion battery, a composite material of graphite as an active material and a binder is used as the powder P. The binder may be, for example, at least one selected from polyvinylidene fluoride (PVDF), vinylidene fluoride-hexafluoropropylene copolymer (PVDF-HEP), styrene-butadiene rubber (SBR), carboxymethyl cellulose (CMC), polyacrylic acid (PAA), polyamideimide (PAI), and polyimide (PI).

A screen 18B is provided in the discharge port of the hopper 18. The screen 18B is electrically conductive and has a predetermined pattern. For example, the screen 18B may be an electrically conductive screen in which portions of the pattern are formed of a mesh-material. Since the powder P is applied to the base material 14 through the screen 18B, the base material 14 can be coated with the powder P in a desired pattern.

The screen 18B is not particularly limited as long as it is electrically conductive. For example, a wire rod such as stainless steel containing iron as a main component, galvanized iron, brass, or copper may be used. The size of the mesh is not particularly limited, and may be appropriately changed according to the pattern.

Here, the screen 18B and the conveying unit 12 are electrically connected to the power supply 16, respectively, and are configured such that the power supply 16 can apply a voltage between the screen 18B and the conveying unit 12. When the powder passes through the screen 18B, the powder P can be charged by contacting the powder P.

An ultrasonic transducer 20 is connected to a sidewall of the hopper 18 on the main body portion 18A. The structure and method of the ultrasonic transducer 20 are not particularly limited as long as the vibrator is capable of applying ultrasonic vibration to the powder in the hopper 18.

In the present embodiment, as an example, the ultrasonic transducer 20 is connected to a portion of the hopper 18 that is located below a middle portion in the up-down direction of the hopper 18. In particular, the connecting position of the ultrasonic transducer 20 is preferably a position where the amplitude of the vibration applied to the powder passing through the screen 18B is 50% or more with respect to the amplitude of the ultrasonic transducer 20.

In addition, the ultrasonic transducer 20 is preferably connected to a middle portion in the longitudinal direction of the hopper 18 from the viewpoint of uniformly applying ultrasonic vibration to the powder P stored in the hopper 18.

### Action

Next, the operation of the battery electrode material coating device 10 according to the present embodiment will be described.

In the battery electrode material coating device 10 according to the present embodiment, the electrically conductive base material 14 is conveyed by the conveying unit 12. Further, the hopper 18 is configured to be capable of accommodating the powder P, and the hopper 18 includes an electrically conductive screen 18B. Further, a voltage can be applied between the conveying unit 12 and the hopper 18 by the power supply 16. As a result, a predetermined amount of the powder P is supplied from the hopper 18 to the base material 14 conveyed by the conveying unit 12, so that the base material 14 is coated with the powder P.

Here, the ultrasonic transducer 20 is connected to the sidewall of the hopper 18. Therefore, the powder P with ultrasonic vibration applied thereto can be supplied from the screen 18B to the base material 14, and the base material 14 that is a coating target can be uniformly coated with the powder.

Further, in the present embodiment, since the screen 18B is provided in the discharge port of the hopper 18, the powder P immediately after passing through the screen 18B can be supplied to the base material 14.

Further, in the present embodiment, since the ultrasonic transducer 20 is connected to the portion of the hopper 18 that is located below (downstream of) the middle portion in the up-down direction of the hopper 18, ultrasonic vibration can be effectively applied to the powder P near the discharge port of the hopper 18. That is, when the ultrasonic transducer 20 is connected to the upper portion of the hopper 18, the vibration applied to the powder P in the vicinity of the discharge port due to the damping becomes small, and there is a possibility that the effect of the ultrasonic vibration cannot be sufficiently obtained. In the present embodiment, the ultrasonic transducer 20 is connected to a position close to the discharge port of the hopper 18, so that the ultrasonic vibration before the attenuation can be applied to the powder P as described above.

Furthermore, in the present embodiment, the hopper 18 is disposed in such a manner that the longitudinal direction of the hopper 18 is perpendicular to the conveying direction of the base material 14 by the conveying unit 12. In other words, since the length of the discharge port of the hopper 18 in the conveying direction is reduced, the powder can be more uniformly applied in the conveying direction of the base material 14.

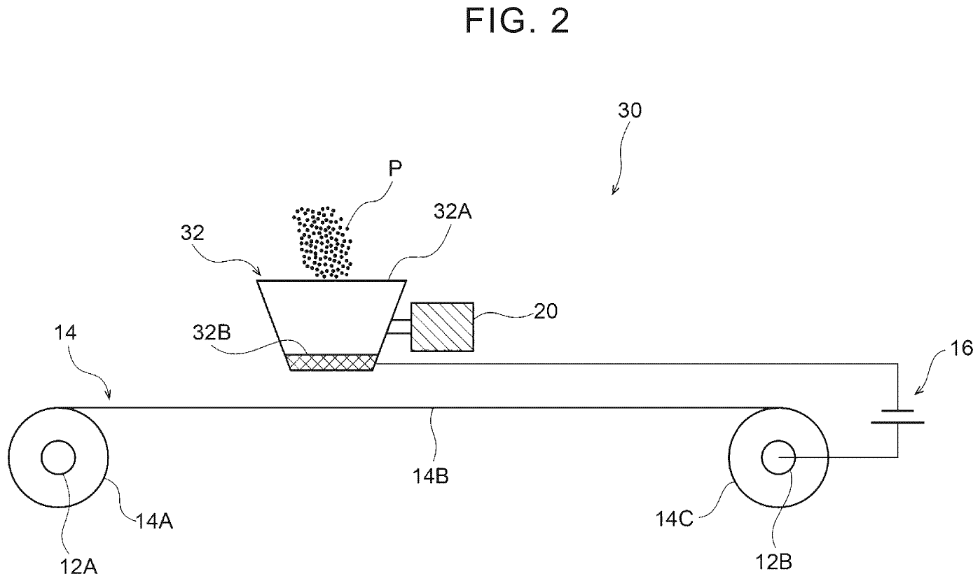

In the present embodiment, the length of the hopper 18 of the body portion 18A in the conveying direction is set to 10 mm or less, but the present disclosure is not limited to this. For example, the structure of the modification shown in FIG. 2 may be adopted.

### Modification

FIG. 2 is a diagram schematically illustrating an overall configuration of a battery electrode material coating device 30 according to a modification. As shown in FIG. 2, the battery electrode material coating device 30 according to the present modification has the same configuration as that of the embodiment except for the hopper 32.

The length of the hopper 32 in the conveying direction is longer than that of the hopper 18 in the embodiment, and is set to, for example, about 30 mm.

In the battery electrode material coating device 30 according to the present modification, as in the battery electrode material coating device 10 according to the embodiment, the ultrasonic transducer 20 is connected to the sidewall of the hopper 32 on 32A of the main body, so that the base material 14 can be uniformly coated with the powder P.

Hereinafter, the evaluation results of the battery electrode material coating device 10 according to the present disclosure and a battery electrode material coating device 100 of the comparative example will be described. First, the battery electrode material coating device 100 of the comparative example will be described, and thereafter, the evaluation procedure will be described.

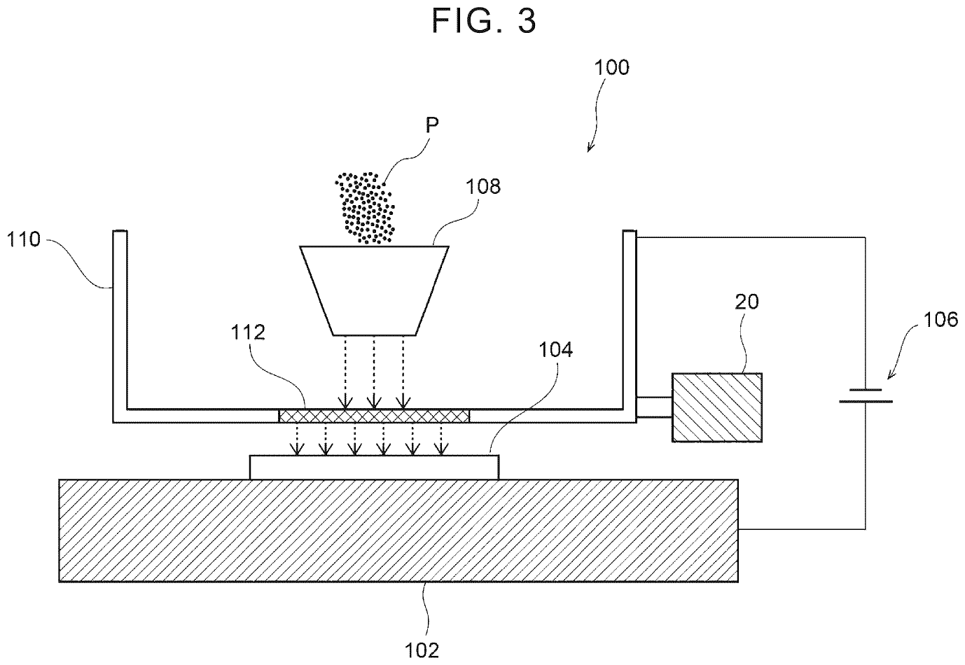

FIG. 3 is a diagram schematically showing an overall configuration of the battery electrode material coating device 100 according to a comparative example. As illustrated in FIG. 3, the battery electrode material coating device 100 of the comparative example includes a base material holder 102, a hopper 108, a screen 112, a power source 106, and an ultrasonic transducer 20.

In the structure of the comparative example, the hopper 108 and the screen 112 are separated from each other. Specifically, a frame body 110 having a bottomed cylindrical shape and conductivity is disposed below the hopper 108, and an electrically conductive screen 112 is disposed at the bottom of the frame body 110. In the structure of the comparative example, the power source 106 is installed so that a voltage can be applied between the frame body 110 and the base material holder 102.

Further, in the structure of the comparative example, the ultrasonic transducer 20 is connected to the sidewall of the frame body 110, and the ultrasonic transducer is applied to the frame body 110 so that the ultrasonic transducer is applied to the screen 112 via the frame body 110. The powder P supplied from the hopper 108 to the frame body 110 is subjected to ultrasonic vibration when passing through the screen 112, and is applied to the base material 104 installed in the base material holder 102. In the configuration of the comparative example, the length of the hopper 108 in the short-side direction (the left-right direction of the drawing) is set to be longer than that of the hopper 18 of the embodiment and to be 50 mm.

The evaluation procedure is as follows.

### (1) Composite of Negative Electrode Materials

As powder for coating, graphite and PVDF were put into a MP mixer (manufactured by Nippon Coke Industries Co., Ltd.), and combined treatment was carried out under the conditions of 10000 [rpm] and 2 [min].

The average particle size of the graphite was 10 to 20 [μm]. Further, the composition-ratio of graphite and PVDF was set to 97.5/2.5 [wt %].

### (2) Film Formation

In the battery electrode material coating device 10 shown in FIG. 1, the composite-treated powder P was supplied to the hopper 18, and the powder P was applied through a screen 18B set to 300 mesh to a 100 [mm]×50 [mm] of the base material 14. On the other hand, in the battery electrode material coating device 100 shown in 3, the composite-treated powder P was supplied to the hopper 108, and the powder P was applied from the screen 112 set to 300 mesh to the base material 104 in 100 [mm]×50 [mm] range.

### (3) Fixing and Densification

The powder P is fixed on the base material 14 by pressing at 150 [C] and 5 [kN] for 1 minute using a flat press. In the same procedure, the powder P is fixed to the base material 104 to prepare an electrode.

### (4) Measurement of Electrode Weight

The fabricated electrodes were punched in 12 places and weighed by an electronic balance.

Table 1 below calculates the dispersion of the weight of 12 locations.

TABLE 1

| | Examples | Comparative Example |
|---|---|---|
| Weight Variation [%] | ±17 | ±59 |

From the results shown in Table 1, it can be seen that by performing coating using the battery electrode material coating device 10 according to the example, the variation in weight at the time of electrode production can be reduced as compared with the case where the battery electrode material coating device 100 according to the comparative example is used. Since the weight of the electrode depends on the amount per unit area of the powder P to be applied, it can be seen that the powder P can be applied more uniformly in the examples than in the comparative examples.

In the present embodiment, as shown in FIG. 1, the ultrasonic transducer 20 is connected to a portion of the hopper 18 that is located below the middle portion in the up-down direction of the hopper 18. However, the present disclosure is not limited to this. For example, the ultrasonic transducer 20 may be connected to the middle portion in the up-down direction of the hopper 18.

Further, a structure using a plurality of ultrasonic transducers 20 may be employed. For example, two or more ultrasonic transducers 20 may be connected along the longitudinal direction of the hopper 18.

Further, in the present embodiment, the conveying unit 12 includes the supply-side roller 12A and the recovery-side roller 12B, but the present disclosure is not limited thereto, and other structures may be adopted as long as the structure can convey the base material 14. For example, in a case where the base material is not in the form of a roll but in the form of a sheet, the base material may be conveyed by a belt or the like.

With respect to the above embodiments, the following supplementary notes are disclosed.

### Appendix 1

A battery electrode material coating device includes:
a conveying unit configured to convey an electrically conductive base material;
a hopper configured to store powder and including an electrically conductive screen;
a voltage applying unit configured to apply a voltage between the conveying unit and the hopper; and
an ultrasonic transducer connected to a sidewall of the hopper.

### Appendix 2

In the battery electrode material coating device according to Appendix 1, the screen is installed in a discharge port of the hopper.

### Appendix 3

In the battery electrode material coating device according to Appendix 1 or 2, the ultrasonic transducer is connected to a portion of the hopper that is located below a middle portion in an up-down direction of the hopper.

### Appendix 4

In the battery electrode material coating device according to any one of Appendices 1 to 3, the hopper is disposed in such a manner that a longitudinal direction of the hopper is perpendicular to a conveying direction of the base material by the conveying unit, and the ultrasonic transducer is connected to a middle portion in the longitudinal direction of the hopper.

What is claimed is:

1. A battery electrode material coating device, comprising:
a conveying unit configured to convey an electrically conductive base material;
a hopper configured to store powder and including an electrically conductive screen;
a voltage applying unit configured to apply a voltage between the conveying unit and the hopper; and
an ultrasonic transducer connected to a sidewall of the hopper.

2. The battery electrode material coating device according to claim 1, wherein the screen is installed in a discharge port of the hopper.

3. The battery electrode material coating device according to claim 1, wherein the ultrasonic transducer is connected to a portion of the hopper that is located below a middle portion in an up-down direction of the hopper.

4. The battery electrode material coating device according to claim 1, wherein
the hopper is disposed in such a manner that a longitudinal direction of the hopper is perpendicular to a conveying direction of the base material by the conveying unit, and
the ultrasonic transducer is connected to a middle portion in the longitudinal direction of the hopper.
